(19) United States
(12) Patent Application Publication
(10) Pub. No.: US 2008/0095415 A1
(43) Pub. Date: Apr. 24, 2008

(54) Ultrasonic Myocardial Tagging

(75) Inventor: Christopher Hall, Briarcliff (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/572,569

(22) PCT Filed: Jul. 11, 2005
(86) PCT No.: PCT/IB05/52295

§ 371 Date: Nov. 20, 2007

(30) Foreign Application Priority Data
Jul. 26, 2004 (US) 60 591 072

(51) Int. Cl. G06K 9/00

(52) U.S. Cl. 382/128

(57) ABSTRACT

The present invention relates to an ultrasonic myocardial tagging and imaging system (30), in which an ultrasonic contrast agent, e.g. microbubbles, is introduced to the myocardial area and allowed to circulate. a high-MI pressure field is applied to selectively destroy regions of the contrast agent in a known geometry so as to create a “tag” (102) comprising a predetermined pattern of non-echogenic regions (102b) and echogenic regions (102a). Movement of the tag (102) relative to the myocardium (100) is tracked so as to monitor movement and/or de formation of the wall tissue and assess myocardial viability.

### FIELD OF THE INVENTION

This invention relates generally to myocardial tagging techniques and, more particularly, a system and method for tracking myocardial wall motion through the use of ultrasonic contrast agents and an ultrasonic imaging system.

### BACKGROUND OF THE INVENTION

Heart performance can be assessed by measuring the detailed strain patterns of the myocardium. Strain patterns can reflect the normal and abnormal myocardial motion, which can be used to correlate the myocardial motion abnormalities with coronary artery disease. Regional wall-motion abnormalities are an excellent indicator of coronary stenosis, and actually precede both ECG abnormalities and chest pain as an indicator of myocardial ischemia. In recent years, several techniques have been developed for fast and accurate tracking of cardiac wall motion.

MRI (magnetic resonance imaging) myocardial tagging is a well-developed method for the evaluation of regional myocardial motion abnormalities, and the development of tagged cardiac magnetic resonance imaging has led to a set of analysis tools that greatly assist in the non-invasive assessment of heart performance because MRI tagging provides very precise quantitative estimates of muscle shortening and thickening. In this method, a thin plane of myocardial tissue is saturated using a sequence of radio frequency pulses. Saturated myocardium does not give any MRI signal during myocardial contraction. Thus, myocardial tags deform with the underlying myocardium during systole and diastole. Postprocessing software can accurately estimate tag displacement to within 0.1 mm, and the temporal tag displacement can be processed to compute 3D myocardial strain maps.

For example, International Patent Application No. WO02/37416 describes a method and system for tag detection and tracking in MRI tagged images.

Historically, the use of myocardial tagging has been infrequent due to the limited availability of easy-to-use software and an inexpensive imaging modality. In recent years, the use of magnetic resonance imaging to perform tagged imaging has become more widespread, but although tagging allows the fall 3D displacement field to be calculated, this method is time-consuming and relatively expensive. Thus, two-dimensional analysis in the circumferential and radial directions is currently more often used because the analysis is more rapid and, therefore, considered to be more practical. However, such two-dimensional analysis is still hampered by the expense, and also by limited spatial resolution.

### SUMMARY OF THE INVENTION

We have now devised an improved arrangement, and it is an object of the present invention to provide a system and method for myocardial tagging and imaging with an improved spatial resolution relative to the above-described MRI myocardial tagging, without the corresponding implications in respect of cost and data acquisition time.

Thus, in accordance with the present invention, there is provided an ultrasonic tagging and imaging system for tracking movement and/or deformation of an anatomical region of interest in respect of which an ultrasonic contrast agent has been introduced and circulated, the system comprising means for applying an ultrasonic pressure field to said anatomical region of interest so as to selectively destroy regions of said contrast agent and create a tag comprising a predetermined pattern of echogenic and non-echogenic regions in respect of said anatomical region of interest, ultrasonic imaging means for generating an image of said anatomical region of interest including said tag, and means for tracking movement and/or deformation of said anatomical region of interest by tracking movement and/or deformation of said tag.

Also in accordance with the present invention, there is provided a method for imaging an anatomical region of interest and tracking movement and/or deformation thereof, in respect of which anatomical region of interest an ultrasonic contrast agent has been introduced and circulated, the method comprising applying an ultrasonic pressure field to said anatomical region of interest so as to selectively destroy regions of said contrast agent and create a tag comprising a predetermined pattern of echogenic and non-echogenic regions in respect of said anatomical region of interest, generating an image, using ultrasonic imaging means, of said anatomical region of interest including said tag, and tracking movement and/or deformation of said anatomical region of interest by tracking movement/deformation of said tag.

Thus, the present invention provides the ultrasonic tagging equivalent to MRI tagging, in the sense that the additional clinical information available to the clinician in respect of the visualisation of the motion of the heart muscle is provided without the associated disadvantages, i.e. the ultrasonic tagging system of the present invention provides the advantages of MRI tagging but the imaging technology (i.e. ultrasound) is relatively inexpensive and an increased spatial resolution is achievable.

In a preferred embodiment of the present invention, the contrast agent comprises microbubbles consisting of gas bubbles surrounded by a membrane, wherein said ultrasonic pressure field has a sufficiently high mechanic index at selected locations therein to selectively destroy said microbubbles in regions of said anatomical region of interest corresponding to said selected locations of said pressure field. In one exemplary embodiment, the system comprises three-dimensional ultrasonic imaging means for applying ultrasonic energy to said anatomical region of interest in multiple planes, wherein said predetermined pattern corresponds to a selected one or more of said planes. In this case, data acquisition may be more arduous, but the image processing is relatively straight forward. In an alternative embodiment, a two-dimensional ultrasonic imaging means may be employed, wherein a transducer array is arranged and configured to apply the pressure field in a predetermined pattern. In this case, the data acquisition is relatively simple, although the image processing step may be more complex.

In a preferred embodiment, the non-echogenic regions of said tag are spatially mapped onto an image of the tissue of said anatomical region of interest so as to enable the movement and/or deformation of said tissue to be monitored for some predetermined time, cycle, or set of cycles. For example, where the anatomical region of interest is the myocardium, the movement and/or deformation of the tissue wall of the myocardium may be monitored throughout one or more heart cycles.

In a preferred embodiment of the invention, the system may be arranged and configured to re-apply said pressure field, to re-destroy said contrast agent, periodically. For example, where the anatomical region of interest comprises the myocardium, the system may be arranged and configured to re-apply the pressure field to re-destroy selected regions of the contrast agent in respect of each heartbeat, and a cardiac signal representative of the patient's heartbeat may be gated for this purpose.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 is a schematic block diagram of an ultrasonic myocardial tagging and imaging system according to an exemplary embodiment of the present invention;

FIG. 2 is a schematic flow diagram of an ultrasonic tagging and imaging method performed by a system according to an exemplary embodiment of the present invention;

FIGS. 3a (i) and (ii) illustrate schematically the effect of the introduction of an ultrasonic contrast agent on a displayed image of a myocardium, relative to the short axis and the long axis respectively;

FIG. 3b (i) illustrates schematically the effect of the pre-patterned destruction of the contrast agent on a displayed image of the myocardium relative to the short axis;

FIG. 3b (ii) illustrates schematically the effect of a single high-MI scan plane applied to destroy the contrast agent, in respect of a displayed image of the myocardium relative to the long axis;

FIG. 3b (iii) illustrates schematically the effect of multiple high-MI scan planes applied to destroy the contrast agent, in respect of a displayed image of the myocardium relative to the long axis;

FIG. 4a(i) is a schematic side view of a transducer array for use in a 2D imaging system according to an exemplary embodiment of the present invention;

FIG. 4a(ii) illustrates schematically a grid-like pressure pattern (bearing in mind that the pattern does not necessarily have to precisely be a grid, because the pre-planned contrast agent destruction occurs at a set (known) threshold);

FIGS. 4b(i) and (ii) illustrate schematically the effect of the contrast agent relative to a displayed, short axis image of the myocardium, respectively before and after destruction of the contrast agent in the pre-planned grid-like geometry; and

FIG. 4b(iii) illustrates schematically the effect on the tag provided by the patterned geometry of the contrast agent in response to movement of the myocardium.

### DETAILED DESCRIPTION OF THE INVENTION

Thus, as explained above, myocardial tagging provides a clinician with information about the ability of a heart to contract, by labelling specific segments of the heart muscle and following them throughout the heart cycle. The present invention involves the use of an ultrasound imaging system in conjunction with an ultrasonic, microbubble contrast agent to follow motion of the heart muscle, with the same effective clinical utility as current MRI tagging methods, without the associated limitations in relation to spatial resolution, data acquisition time and cost.

Ultrasonic imaging systems are known which make use of contrast agents in circulation to enhance ultrasound returns, and such contrast agents are currently primarily used for blood pool measurements of left ventricular opacification to visualise the myocardium and flow patterns through valves. Another desired use for ultrasonic contrast agents is in the assessment of perfusion of the heart muscle, and several clinical trials are underway.

Contrast agents are substances which strongly interact with ultrasound waves and return echoes which may be clearly distinguished from those returned by blood and tissue. Microbubbles are currently employed as a contrast agent and provide a non-linear behaviour in certain acoustic fields. In general, microbubbles have been found to be useful for imaging of the body's vascular system, and are injectable through the veins and arteries. They are subsequently filtered from the blood stream by the lungs, kidneys and liver.

Microbubble contrast agents generally comprise coated gas bubbles that are stable in the body for a significant period of time. The coating shells serve to protect the gas from diffusion into the blood stream.

In more detail, microbubbles are gas (air or inert gas) bodies ranging from 1 to 7 microns in diameter, enclosed by some sort of membrane (e.g. a protein, lipid or polymer layer). One known type is an air-containing microbubble made by shaking galactose micro particles with water. The galactose micro particles contain micro defects, which constrain the attached air microbubbles to the requisite size. They are stabilised by a monomolecular layer of surfactant, palmitic acid. Another known type of microbubble uses a high-density gas (sulphur hexafluoride) which improves the longevity of the microbubbles on account of its high molecular weight, which slow diffusion. Its membrane is a phospholipids which is similar to cell membranes.

The essence of the function of contrast agents like microbubbles is that they behave quite differently from solid or watery tissue. Microbubbles, for example, can be compressed and expanded more readily than such tissue. Ultrasound consists of oscillations of high a low pressure and a microbubble subjected to ultrasound will grow and shrink accordingly—it will start to oscillate at the frequency of the ultrasound. At higher ultrasound intensity (or mechanic index—MI), the oscillations become more extreme and non-linear behaviour will start to occur. The microbubbles will produce higher harmonics, e.g. at twice or three times the fundamental frequency, and they may even be destroyed by a field having a MI greater than some predetermined threshold.

Microbubbles tend to have a natural resonant frequency at which they respond most actively, and the resonant frequency for 1 to 7 micron microbubbles lies in the 2-10 MHz range that is used for diagnostic imaging. This results in the remarkable reflectivity of microbubbles, which are many-fold echogenic than comparable tissue elements, such as red blood cells.

As explained briefly above, in the case of microbubble contrast agents, at moderately high ultrasound pressure amplitudes, the shells of the microbubbles can be caused to rupture, freeing the internal gas and substantially reducing the detectability thereof by incident ultrasound waves. One of the more popular methods employed in respect of this type of ultrasonic imaging is to destroy the contrast agent within the imaging plane by means of the use of a high-pressure (i.e. high mechanic index or MI) ultrasonic field, and then to image the rate of restoration of the contrast signal in these areas to quantify blood supply. For example, U.S. Pat. No. 5,833,613 discloses an ultrasound method for imaging of contrast agents. In one embodiment, a rate of re-perfusion of an anatomical region is accomplished by initially destroying the contrast agent, and then subsequently imaging the region to determine the rate of re-insertion of the contrast.

In accordance with the following exemplary embodiments of the present invention, there is provided an ultrasonic tagging and imaging system for non-invasive tracking of wall motion in respect of an anatomical region, wherein an ultrasonic contrast agent is introduced and a pre-planned pattern of scan/planes and/or scan lines at a sufficiently high MI is used to destroy the contrast agent so as to produce a known pattern of non-echogenic regions on the imaging plane. By tracking these non-echogenic regions through their position and deformation, an assessment of, for example, myocardial function can be obtained. The technique of the present invention is similar, or at least analogous, to the MRI tagging techniques described above, in that a specific portion of the anatomical region of interest, e.g. the heart muscle, is given a traceable property through interaction with an externally-applied field.

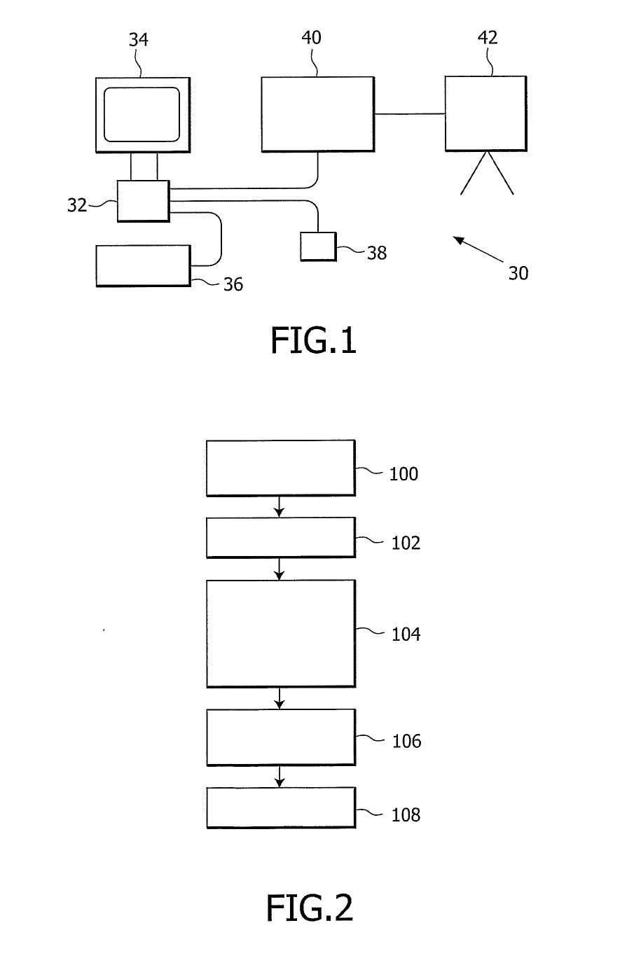

Referring to FIG. 1 of the drawings, an ultrasonic tagging and imaging system 30 for non-invasive tracking of wall motion in respect of an anatomical region comprises a central processing unit (CPU) 32 that is coupled to a graphics display 34, and to a keyboard 36 for input of data or instructions controlling the image processing and modelling procedures used to track wall motion in respect of an anatomical region of interest. In addition, a mouse 38 (or other cursor pointing device) is coupled to the CPU 32 for use in graphically controlling the software running on the CPU 32, for example, by selection of menu items, or for manually tracing images produced on the graphics display 34. The CPU 32 is coupled through an appropriate input card or port (not shown) to an analog-to-digital converter (ADC) and image processor 40. The ADC and image processor 40 receives an analog signal produced by an imaging device 42 and converts it to a digital signal, and then processes the digital signal to create an appropriate signal for input to the CPU 32 and display on the graphics display 34. In addition, the ADC and image processor 40 control the imaging device as to applies ultrasonic pulses/fields to the anatomical region of interest.

Referring to FIG. 2 of the drawings, there is provided a flow diagram illustrating the principle steps of an ultrasonic myocardial tagging and imaging method according to an exemplary embodiment of the present invention. In the first instance, a patient is injected with an ultrasonic contrast agent, such as microbubbles or the like, by any known method such as bolus or infusion (step 200).

The agent is allowed to circulate (step 202) so that, in this case, it fills the ventricles and atria, and enters the myocardium. Then, a high pressure (i.e. high MI) ultrasonic field is applied to the anatomical region of interest (in this case, the patient's heart) in the form of a pre-planned pattern of scan planes and/or scan lines, so as to create therein a (known) corresponding pattern of non-echogenic regions (step 204).

Next, the heart is imaged (step 206) using a low-MI mode of the ultrasonic imaging device and movement of the echo-poor (anechoic) regions is tracked (step 208) and (preferably) quantified by mapping motion and deformation of these regions to functional parameters.

There are many methods for performing motion tracking of the anechoic regions. These tend usually to be centered on the premise of removing the translation (movement) portion from the deformation component. For translation removal, a few approaches include a simple centroid tracking; statistical (information-theoretic) tracking; texture tracking, optical flow, and others (see for example Maintz, J. B. and M. A. Viergever, A survey of medical image registration. Medical image analysis, 1998. 2(1): p. 1-36. For deformation, approaches usually involve the motion of the edges (transitions between tagged and non-tagged tissue). Typically, these monitor the motion of the vertices of the tagged structure and measure shear and longitudinal strain in this manner. Heart twist can also be measured the motion of the tagged region within the 3D spatial dataset across multiple times. In any event it will be appreciated by a person skilled in the art that many different motion-tracking techniques are known, particularly in relation to MRI tagging, and some examples are given in:

McVeigh, E. R., MRI of myocardial function: motion-tracking techniques. Magnetic Resonance Imaging, 1996. 14(2): p. 137-150;
Metaxas, D. N., et al. Segmentation and analysis of 3D cardiac motion from tagged MRI images. in Engineering in Medicine and Biology Society, 2003, Proceedings of the 25^{th} Annual International Conference of the IEEE. 2003;
Park, J., et al., Deformable models with parameter functions for cardiac motion analysis from tagging MRI data. Medical Imaging, IEEE Transactions on, 1996. 15(3): p. 278-289;
Vincent, F., et al. An elasticity-based region model and its application to the estimation of the heart deformation in tagged MRI. In Image Processing, 2000 Proceedings. 2000 International Conference on. 2000; and
Young, A., et al., Validation of tagging with MR imaging to estimate material deformation. Radiology, 1993. 188(1): p. 101-108.

The resultant output is an array of vectors showing tissue motion and deformation that can be overlayed over a traditional image of the anatomical region of interest. Accordingly, this movement (and deformation) can be interpreted as movement/deformation of the underlying heart muscle.

The method of the invention can be applied in either two-or three-dimensional imaging systems, as will now be described in more detail.

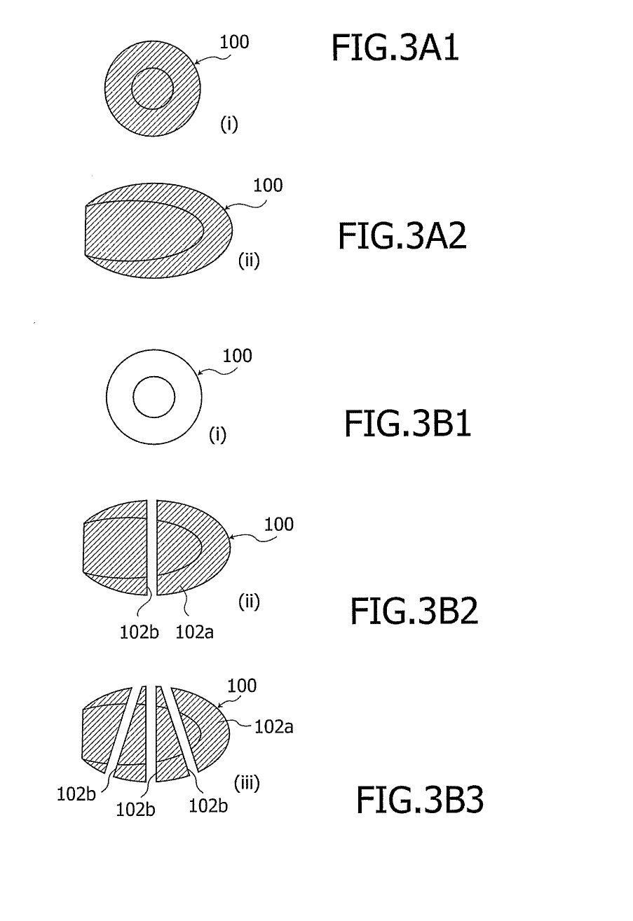

In a first specific exemplary embodiment of the present invention, a 3D ultrasonic imaging system is employed. As explained above, first a patient is injected with an ultrasonic contrast agent, and the contrast agent is allowed to circulate so that it fills the ventricles and atria, and enters the myocardium. Referring to FIG. 3a of the drawings, the myocardium 100 can be imaged in bi-plane using a 3D ultrasonic imaging system, namely in the short axis (i) and the long axis (ii). As illustrated by the shaded areas, the contrast in the myocardium caused by the contrast agent, relative to the background, can be clearly seen.

Next, the scan sequence of the ultrasonic probe of the imaging device is modified such that one or more scan planes are fired at high pressure (high mechanical index (MI)) in order to destroy the contrast agent in those planes. It will be appreciated that many different designs of suitable ultrasonic probes are known to a person skilled in the art, and such designs will not be discussed in any further detail herein. Suffice to say that most conventional ultrasonic probes are arranged and configured to produce a plurality of images along respective planes, and such images are displayed on the graphics display. Thus, a predetermined pattern of scan planes can be fired at high pressure to produce the desired pattern (or tag 102) of echogenic (102a) and non-echogenic (102b) regions.

The heart is subsequently imaged in a low-MI mode so that the planes of high MI are visualised as non-echogenic portions of the image. In this exemplary embodiment of the present invention, the ultrasonic probe is arranged and configured to produce a plurality of images along respective planes along the short axis of the anatomical feature of interest, such that, in the plane corresponding to the short axis, as illustrated in FIG. 3b(i), the contrast is entirely destroyed. In the case of the long axis view, FIG. 3(b)(ii) illustrates the contrast destruction (102b) in a single plane, and FIG. 3(b)(iii) illustrates the contrast destruction in the case of a multi-planar pattern (102b).

Many different forms of ultrasonic imaging techniques are well known in the art, and the present invention is not intended to be limited in this regard. For example, one of the more basic techniques involves the application of a train of pulses to an anatomical region of interest, and the comparison of echoes therefrom so as to search for discrepancies between consecutive signals. Any changes are recorded as movement. The fundamental frequency echo signals are used in this case for image formation.

In an alternative arrangement, a frequency filter may be applied to reject the fundamental frequency, and select instead the second (higher) harmonic(s) for image formation.

On the other hand, various multi-pulse techniques exist for extracting non-linear signals. For example, a phase inversion technique exists, whereby two pulses are sent down each line, the second being of opposite phase to the first. If there is a completely linear response (either from tissue or microbubbles), the returning signals are mirror images of each other and cancel when they are added. Any non-linearity leaves a residual signal and this can be used to form images. This method gives relatively high resolution images. Another example of a multi-pulse technique is described in U.S. Pat. No. 6,652,463 wherein a pulse train is generated in which three distinct pulses are fired: the first pulse being generated by firing the “even” numbered elements within the ultrasonic transducer, the second pulse being generated by controllably firing all elements of the transducer. The third pulse may be generated by firing the “odd” numbered elements of the transducer element array. It will be appreciated by persons skilled in the art that more than three pulses may be generated and fired to further extend a multi-pulse insonification and imaging technique.

In any event, whichever method of imaging is employed, the non-echogenic slices/lines (102b) (depending on which plane is observed) will tend to remain for several heart cycles in the myocardium 100. This allows for the tracking and quantification of the deformation and movement of the echo-poor regions (102b) by the processor 40, and this deformation and movement can be interpreted as movement/deformation of the underlying heart muscle.

However, refreshing of the non-echogenic scan planes can be accomplished, if necessary, by re-firing the high-MI pressure field (i.e. re-destroying the contrast agent in the pre-planned pattern) at regular intervals: for example, an EKG signal may be available which follows the heartbeat, so the non-echogenic regions can be refreshed by re-firing the high-MI pressure field in response to every heartbeat by gating off the EKG signal.

The need for “refreshing” of the tagged areas could occur because, for example, a pre-determined period of time has elapsed, quality of the image is assessed, etc. The overall driving factor is that the tagged regions will become echoic (filled with contrast) over several heartbeats as the contrast “washes-in” or re-perfuses the tissue. The idea of refreshing the tags is to counter this effect. The reason for synchronising this with the heart phase at least in some circumstances is to allow for repeatable spatial geometry of the tag lines (i.e. the heart should return to roughly the same 3D position at the end of systole or diastole - an approximation, but not a poor one). Thus the refreshing of the tag lines is only necessary if the heart is imaged over an extended period of time that includes multiple beats.

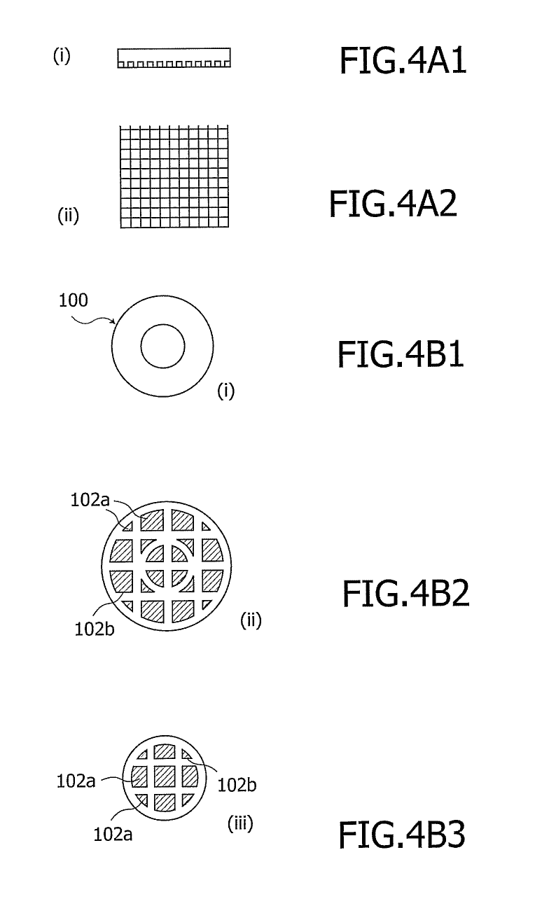

In a second exemplary embodiment of the present invention, a 2D ultrasonic imaging system may be used. In this case, once again, the patient is injected with an ultrasonic contrast agent, either by bolus or infusion, and the agent is allowed to circulate so that it fills the ventricles and atria and enters the myocardium 100. The resultant contrast is illustrated schematically in FIG. 4b(i), relative to the short axis.

The 2D imaging system includes a transducer array 200 (see FIG. 4a(i))and it is possible to produce therewith a pressure field with an arbitrary shape (examples include a grid (see FIG. 4(a)(ii)), a spoked wheel, a series of lines, a grid of dots, etc.) by choosing an appropriate transmit pulse and delay combination so as to destroy the contrast in a specific pattern (wherein the appropriate transmit pulse can be calculated beforehand to obtain the exact pressure field desired). To construct an arbitrarily shaped pressure field in 2D or 3D imaging, one approach is to employ the inverse problem. This approach starts with the desired pressure field and divides the high MI field into infinitesimally small point sources. By tracking the wave fronts from these point sources back to the position of the insonifying array, it is possible to reconstruct the waveforms necessary to transmit on each transducer element in order to get the desired high MI field. This idea is a basic physical phenomenon, and utilizes the fact that the propagation of ultrasound waves is symmetric in time (time reversal is possible) so that the source and receiver can be interchanged (see, for example Fink, M., Time-Reversed Acoustics. Scientific American, 1999. November: p. 91-97.

It will be appreciated that the resultant transmitted pressure field need not be used for imaging as it is used merely to destroy the contrast in a specific pattern.

In any event, low-MI imaging is then used post-destruction and the resultant patterned contrast is illustrated schematically in FIG. 4b(ii), again relative to the short axis. In accordance with the invention, movement of the ‘tag’ 102 created by the echogenic (102a) and non-echogenic (102b) regions of the patterned contrast is tracked during, for example, a heart cycle such that, for example, during systole, when the myocardium contracts, the patterned tag contracts accordingly, as illustrated schematically in FIG. 4b(iii). Thus, by analysing the motion of the less (non-) echogenic, destroyed contrast areas, assessment of the motion of the heart muscle can be obtained. Re-firing the high-MI pattern, perhaps on specific portions of an EKG signal so as to follow, for example, the patient's heartbeat, could further augment this method. Furthermore, the above-described 2D method could be further improved by using a wider elevation plane when transmitting the high-MI pulse in order to destroy the contrast out of the imaging plane to account for possible out-of-plane motion of the heart.

It will be appreciated that although the present invention has been described above in terms of tracking the anechoic replies of the tag once the destruction “pattern” has been implanted, it is equally possible to track (alternatively or additionally) the echoic regions. In fact, the transition between these two replies of the tag may be particularly useful, as this provides an edge or boundary to track.

Thus, the present invention is designed to image the motion of tissue in an anatomical region of interest. It accomplishes this by destroying the introduced contrast agent in a regular geometry (and such destruction may be repeated periodically perhaps by gating this function to the cardiac signal monitoring the patient's heartbeat) and then spatially tracking the resultant anechoic and/or echoic regions. These regions can be spatially mapped onto the tissue in order to monitor motion of the tissue throughout some cycle, e.g. heart cycle. The movement or deformation of these regions are expected to give information about the functional viability of the tissue. In summary, in a preferred exemplary embodiment of the invention:
1. Initial signal =tissue +contrast
2. contrast is destroyed in a regular, pre-planned geometry
3. anechoic and/or echoic regions are monitored using low-MI imaging
4. if necessary (but not necessarily essentially), the anechoic regions are re-destroyed on a regular (by heartbeat, for example) basis
5. motion and deformation of regions are (possibly spatially) mapped to functional parameters
6. Output =an array of vectors showing tissue motion and deformation that can be overlayed over a corresponding traditional image, for example.
The present invention is potentially suitable for use in many different ultrasound imaging systems for imaging anatomical regions of interest and could, for example, be used as part of a cardiac suite of applications in respect of existing and future ultrasound imaging systems in stress and resting echo examinations, where wall motion is required to be measured to assess viable myocardium and myocardial reserve. However, it will be appreciated that, while the present invention is considered to be particularly useful in myocardial applications, other applications are envisaged, and the present invention is not intended to be limited in this regard.
It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. An ultrasonic tagging and imaging system for tracking movement and/or deformation of an anatomical region of interest in respect of which an ultrasonic contrast agent has been introduced and circulated, the system comprising means for applying an ultrasonic pressure field to said anatomical region of interest so as to selectively destroy regions of said contrast agent and create a tag comprising a predetermined pattern of echogenic and non-echogenic regions in respect of said anatomical region of interest, ultrasonic imaging means for generating an image of said anatomical region of interest including said tag, and means for tracking movement and/or deformation of said anatomical region of interest by tracking movement and/or deformation of said tag.

2. A system according to claim 1, wherein the contrast agent comprises microbubbles consisting of gas bubbles surrounded by a membrane and wherein said ultrasonic pressure field has a sufficiently high mechanic index at selected locations therein to selectively destroy said microbubbles in regions of said anatomical region of interest corresponding to said selected locations of said pressure field.

3. A system according to claim 1, comprising three-dimensional ultrasonic imaging means for applying ultrasonic energy to said anatomical region of interest in multiple planes, wherein said predetermined pattern corresponds to a selected one or more of said planes.

4. A system according to claim 1, comprising a two-dimensional ultrasonic imaging means, wherein a transducer array is arranged and configured to apply the pressure field in a predetermined pattern.

5. A system according to claim 1, wherein the non-echogenic regions of said tag are spatially mapped onto an image of the tissue of said anatomical region of interest so as to enable the movement and/or deformation of said tissue to be monitored for some predetermined time, cycle, or set of cycles.

6. A system according to claim 1, arranged and configured to re-apply said pressure field, to re-destroy said contrast agent, periodically.

7. A system according to claim 6, wherein said anatomical region of interest comprises a myocardium, and the system is arranged and configured to re-apply said pressure field to re-destroy selected regions of the contrast agent in respect of each heartbeat.

8. A system according to claim 7, wherein a cardiac signal representative of said heartbeat is employed.

9. A method for imaging an anatomical region of interest and tracking movement and/or deformation thereof, in respect of which anatomical region of interest an ultrasonic contrast agent has been introduced and circulated, the method comprising applying an ultrasonic pressure field to said anatomical region of interest so as to selectively destroy regions of said contrast agent and create a tag comprising a predetermined pattern of echogenic and non-echogenic regions in respect of said anatomical region of interest, generating an image, using ultrasonic imaging means, of said anatomical region of interest including said tag, and tracking movement and/or deformation of said anatomical region of interest by tracking movement/deformation of said tag.
